(19) United States
(12) Patent Application Publication
(10) Pub. No.: US 2009/0273675 A1
(43) Pub. Date: Nov. 5, 2009

(54) IR CAMERA AND METHOD FOR USE WITH IR CAMERA

(75) Inventor: Henrik Jonsson, Stockholm (SE)

Correspondence Address: MORRISON & FOERSTER LLP, 425 MARKET STREET, SAN FRANCISCO, CA, 94105-2482, US

(73) Assignee: FLIR SYSTEMS AB, Danderyd (SE)

(21) Appl. No.: 12/114,865

(22) Filed: May 5, 2008

(51) Int. Cl. H04N 5/33

(52) U.S. Cl. 348/164; 348/E05.09

(57) ABSTRACT

An infrared camera is arranged to compensate for temperature variations of the camera by

Recording the output signal of each pixel of the detector during a shutter operation Using the recorded signal from each pixel to update a temperature offset map stored in the camera to ensure uniform signal levels at different camera temperatures, Said code means being arranged to perform the following steps during operation of the camera:
save at least a first temperature offset map during a first shutter operation at a first temperature and a second temperature offset map during a second shutter operation at a second temperature
fit the data from the at least first and second offset maps to a curve
using the curve to compensate for variations in signal output caused by temperature variations.

### TECHNICAL FIELD

The present invention relates to an IR camera and a method for use with an IR camera, to compensate for temperature changes of the camera during operation.

### BACKGROUND AND RELATED ART

IR cameras are adapted to register incoming infrared radiation and present an image dependent on such radiation, typically displaying the temperature in various areas of the object. An IR camera typically comprises optics for focusing the radiation from an object onto a detector, such as a focal plane array. The focal plane array comprises a number of pixels, each pixel constituted, for example, by a microbolometer. The signal from a microbolometer type of focal plane array is related to the temperature of the microbolometer pixel structure. Each pixel is arranged to register incoming radiation in the infrared range, which causes an increase in temperature of the microbolometer. The temperature of the microbolometer is then converted into a signal output of the detector by means of a Read Out Integrated Circuit (ROIC). The radiation emitted from the object is dependent on the object's temperature.

Several factors, other than radiation from the object focused on the focal plane array, may affect the temperature of the microbolometers and therefore the output of the pixels. One major factor is the ambient temperature, that is, the temperature of the IR camera. Radiation registrered by the focal plane array can typically be divided into radiation from the object, as focused by the lens on the focal plane array, and radiation from the camera itself onto the focal plane array. Radiation from the camera is usually a considerable source of the incoming radiation registered by the focal plane array, typically greater than radiation collected from the object.

Also, the focal plane array substrate temperature itself, if not corrected for, will greatly influence the detector output signal. These effects may cause the detector output signal to saturate as the ambient temperature in which the IR camera is used changes from the calibration point of the focal plane array. Also, slight pixel-to-pixel differences in the microbolometer structure, which arise in the manufacturing of these devices, may cause different pixels to exhibit slightly different temperature dependent behaviour. This will cause image quality degradation of the IR camera if not corrected for.

Many cameras use a thermoelectric cooling system to keep the substrate temperature of the focal plane array within an acceptable range. This will eliminate the need to correct for the signal change caused by detector substrate temperature, and eliminate image quality problems arising from pixel-to-pixel differences. Correcting for infra-red radiation caused by the camera itself must still be performed. This is discussed, for example in U.S. Pat. No. 6,515,285. One drawback with such a solution is that it increases the power consumption and manufacturing cost of the focal plane array significantly.

Therefore methods have been developed for compensating for focal plane array substrate temperature variations without using a thermoelectric cooling system. These methods typically addresses the following two problems:

a) Keeping the detector signal output within the valid range, independent of the ambient temperature of the sensor

b) Correcting for image quality effect due to pixel-to-pixel differences in temperature response of the bolometers

The compensation methods disclosed in the above mentioned documents are based on calibration data registered during the manufacturing procedure for the camera. During manufacturing, each individual camera is placed in a test environment. The calibration procedure can be divided into two parts. In the first part, the camera is typically stabilized at two different ambient temperatures. The ROIC of the focal plane array is designed with a controllable parameter which allows changing the signal output response as a function of detector substrate temperature. By trying different values for this parameter, it is possible to find a value which stabilizes the detector output signal enough so that it never saturates, independent of focal plane array substrate temperature.

In the second part of calibration, images are taken at different well-defined temperatures to provide calibration data and the signal output of each pixel at each temperature is determined and stored as calibration parameters in the camera. These data are then used during operation of the camera to compensate for pixel-to-pixel offset signal changes caused by temperature variations. These data are referred to as temperature offset maps in this document. This recording of temperature calibration data at different temperatures is a cumbersome and time-consuming part of the manufacturing process of an IR camera.

The temperature offset map constitutes a digital offset correction that is applied to the signal obtained from the focal plane array in the signal processing unit. Typically, the offset map is used to correct for pixel-to-pixel offset non-uniformities, creating a signal output which is equal for all pixels receiving the same amount of incident radiation. Typically, an infrared camera is equipped with a shutter unit in order to provide the means to, during operation of the camera, block the radiation from external sources from reaching the focal plane array. At specific intervals during operation of the infrared camera the shutter may be activated, providing a known uniform source of radiation to the detector. This may be referred to as Non-Uniformity Correction (NUC) or Flat Field Correction. When the shutter is activated, the signal processor records the signal of each pixel of the focal plane array. This data is used to update the offset-map, so that after update the signal output of the infrared camera, when exposed to the same amount of incident radiation as during the shutter operation, will ouput a uniform signal for all pixels.

By performing non-uniformity corrections as described above at regular intervals during the operation of the infrared camera, the signal uniformity and hence perceived image quality of the infrared camera can be maintained, even if the signal output of pixels would change.

However, for focal plane arrays operating without a thermo electric cooler, the pixel-to-pixel signal output change, caused by heating of cooling of the focal plane array, may be so large that image quality is negatively impacted in a time frame which is shorter than the desired non-uniformity correction frequency. It is also of general interest to the infrared camera user to keep the time between shutter operations as long as possible.

The calibration method described in WO2003/073054 comprises recording (among other things) the signal output level of the sensor at selected ambient temperatures during production of the infrared camera. This calibration data represents a model for the per-pixel signal output level as a function of focal plane array temperature. This calibration data is then used during operation of the infrared camera to predict, based on measured focal plane array temperature, the expected change in per-pixel focal plane array output signal that occur between non-uniformity corrections. The temperature offset map is then updated at a frequency greater than the non-uniformity corrections frequency to compensate for per-pixel signal output variations. Non-uniformity correction is typically still performed during operation of the infrared camera to compensate for pixel-to-pixel variations not fully corrected for by the data collected during calibration.

To generate the temperature offset maps, parts of the calibration procedure must be performed at a number of different temperatures. This procedure, referred to as temperature cycling, is cumbersome, and requires a complex calibration environment.

### SUMMARY OF THE INVENTION

It is an object of the invention to provide a camera that will allow simpler manufacturing process.

One aspect of the invention relates to an infrared camera comprising a focal plane array having a number of pixels, each pixel arranged to produce an output signal in dependence of incident infrared radiation to the pixel, said camera comprising a processing unit, said camera further comprising computer-readable code means which, when executed in the processing unit will cause the processing unit to perform the following steps during operation of the camera:
recording the output signal of each pixel of the detector during a shutter operation
using the recorded signal from each pixel to update a temperature offset map stored in the camera to ensure uniform signal levels at different camera temperatures,

Said code means being arranged to obtain the temperature offset maps during operation of the camera by performing the following steps:
save at least a first temperature offset map during a first shutter operation at a first temperature and a second temperature offset map during a second shutter operation at a second temperature
calculating a fit based on the data from the at least first and second offset maps
using the fit to interpolate between the first and the second temperature to compensate for variations in signal output caused by temperature variations.

Another aspect of the invention relates to a method of temperature compensation in a focal plane array used in an infrared camera during operation of the camera, said method comprising the following steps performed during operation of the camera: Recording the output signal of each pixel of the detector during a shutter operation Using the recorded signal to update a temperature offset map stored in the camera to ensure uniform signal levels at different camera temperatures.

The temperature offset map is obtained during operation of the camera by the following steps:
saving at least a first temperature offset map during a first shutter operation at a first temperature and a second temperature offset map during a second shutter operation at a second temperature
calculating a fit based on the data from the at least first and second offset maps
using the fit to interpolate between the first and the second temperature to compensate for variations in signal output caused by temperature variations.

Hence, the entire initial calibration of the camera can be performed at room temperature, simplifying the manufacturing process by avoiding the need to calibrate at different temperatures. Instead of attempting to make the focal plane array stable by calibration, the invention provides methods for compensating for the inherent instability of the focal plane array as the temperature varies during operation of the camera. The manufacturing environment can also be simplified, since the temperature does not have to be varied.

The calibration performed during manufacturing only needs to comprise detector parameters and calibration data at one ambient temperature, preferably room temperature for simplicity. The non-uniformity correction is basically the same as that described in the background section, but instead of performing the correction on a background temperature offset map recorded during the manufacturing of the camera, the temperature offset maps are recorded during operation of the camera.

Using a default set of detector parameters will lead to differences in the pixel output depending on the ambient temperature, that is, the same pixel will produce different values for the same object temperature as the camera temperature changes. The change in signal output caused by ambient temperature changes may cause the output signal to saturate. The inventive solution is a way of avoiding saturation by comparing the signal level against an internal reference (shutter) and, if necessary, adjusting an internal detector parameter such as bias or offset in combination with a method to compensate temperature offset maps for the signal change caused by such changes in detector parameters.

Preferably, the code means is arranged to compensate for variations in signal output by adjusting the output signal level to avoid saturation. This adjustment may be achieved by adjusting an internal detector parameter such as bias or offset. This may be done by storing an image before and after signal adjustment and using the difference between these images to adjust by at least the first or the second temperature offset map.

The same compensation may be used for all pixels, or compensation may be performed individually for each pixel. The latter will require more computing power but will result in more flexible compensation than the former.

In one embodiment the processing unit is arranged to fit the first and second temperature offset maps to a linear curve. Preferably, however, the processing unit is arranged to store at least an integer number N temperature offset maps, each taken during shutter operation at a different temperature and perform an N-−1 order polynomial fit on the N temperature offset maps. Other types of fits may be used, for example based on Lagrange methods.

According to an aspect of the invention a method is achieved for creating maps that can be used for compensation while the camera is operated, to avoid the need to create background temperature offset maps during calibration.

### BRIEF DESCRIPTION OF THE DRAWINGS

The invention will be described in more detail in the following, by way of example and with reference to the appended drawings in which:

FIG. 1 illustrates an IR camera that may be used according to the invention.

FIG. 2a shows an example distribution of output signals in response to temperature without compensation.

FIG. 2b shows an example distribution of output signals in response to temperature for a detector with a fixed set of detector parameters selected to allow compensation for temperature changes.

FIG. 3 shows an example of one output signal in response to temperature from one pixel for a detector with the novel method presented for temperature compensation.

FIG. 4 is a flow chart of how calibration of the camera during manufacturing may be performed according to one embodiment.

FIG. 5 is a flow chart of temperature compensation of the camera during operation according to an aspect of the invention.

FIG. 6 is a flow chart illustrating the adjustment of offset compensation parameters.

FIG. 7 is a schematic drawing of a calibration line according to an aspect of the invention.

FIG. 8 is a flow chart of the calibration process using the calibration line of FIG. 7.

### DETAILED DESCRIPTION OF EMBODIMENTS

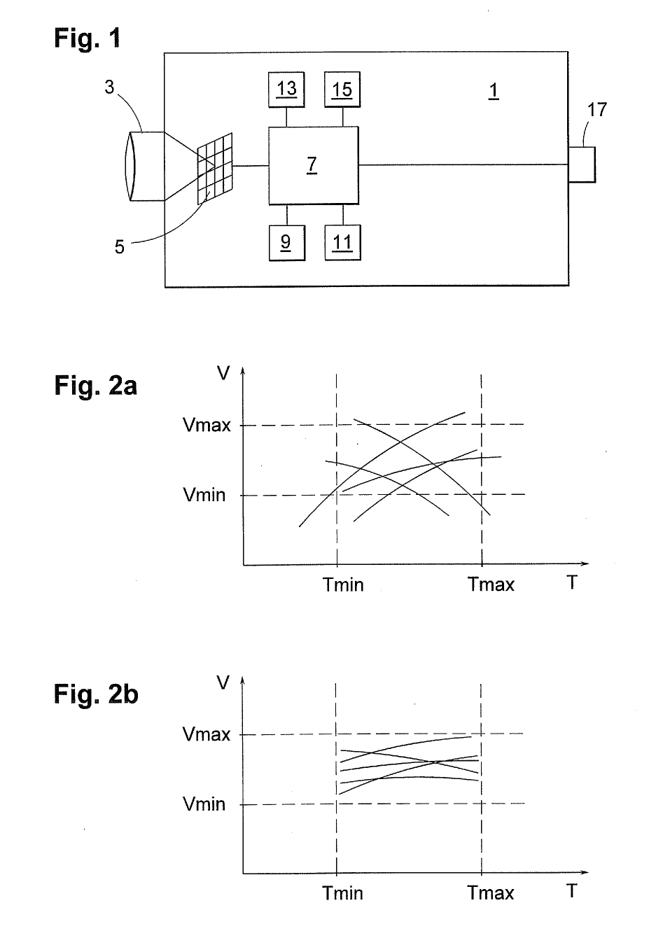

FIG. 1 illustrates an IR camera 1 in which the functions according to the invention may be implemented. The IR camera comprises IR optics 3 for focusing incoming radiation in the IR range onto a focal plan array 5 comprising a number of pixels, each arranged to produce an output signal in dependence of the incoming radiation.

The output signal from each pixel is fed to a processing unit 7 arranged to perform conventional processing on the signals. According to the invention, the processing unit 7 is also arranged to perform certain functions during calibration of the camera during manufacturing. The processing unit 7 is also arranged to perform certain compensation procedures during operation of the camera, to compensate for the temperature variations of the camera. According to an embodiment of the invention these compensation procedures differ from those common in the art, to take into account that the camera does not have calibration parameters for different ambient temperatures. A first memory unit 9 is arranged to hold calibration software to be used according to one aspect of the invention when calibrating the camera during manufacturing process. A second memory unit 11 is arranged to hold calibration data obtained during calibration during the manufacturing process. A third memory unit 13 is arranged to hold dynamic calibration data obtained during operation of the camera to be used for the compensation procedures mentioned above. A fourth memory unit 15 is arranged to store processed image data which can be presented to a user on a viewfinder and/or other type of display 17 and/or transferred to an external device such as a computer (not shown).

As the skilled person will understand, the functions of the processing unit 7 may be divided between two or more processing units as is seen fit. Further, the memory units 9, 11, 13, 15 may be implemented as one or more memory units depending on what is considered feasible.

FIG. 2a illustrates the output signal (vertical axis) from a number of pixels in the focal plane array 7 as a function of the substrate temperature (horizontal axis) without any correction. The minimum and maximum acceptable output signals are indicated as dashed horizontal lines and the minimum and maximum acceptable substrate temperature are indicated as dashed vertical lines. Each solid line represents the characteristic of one pixel. As can be seen, the different pixels have very different response to substrate temperature. Ideally, all pixels should produce an output between the minimum and maximum output voltages for all substrate temperatures between the minimum and maximum substrate temperatures. This is normally accounted for by means of correction procedures based on calibration parameters obtained during manufacturing of the camera.

FIG. 2b illustrates the output signals of FIG. 2a for a prior art detector where specific detector parameters have been selected to allow compensation for most of the signal variation seen in FIG. 2a. As can be seen, the response of each pixel is within the acceptable voltage range, that is, between the minimum voltage level Voutmin and the maximum voltage level Voutmax, in the whole temperature range between Tmin and Tmax. Selecting such specific detector parameters typically requires temperature cycling during manufacturing.

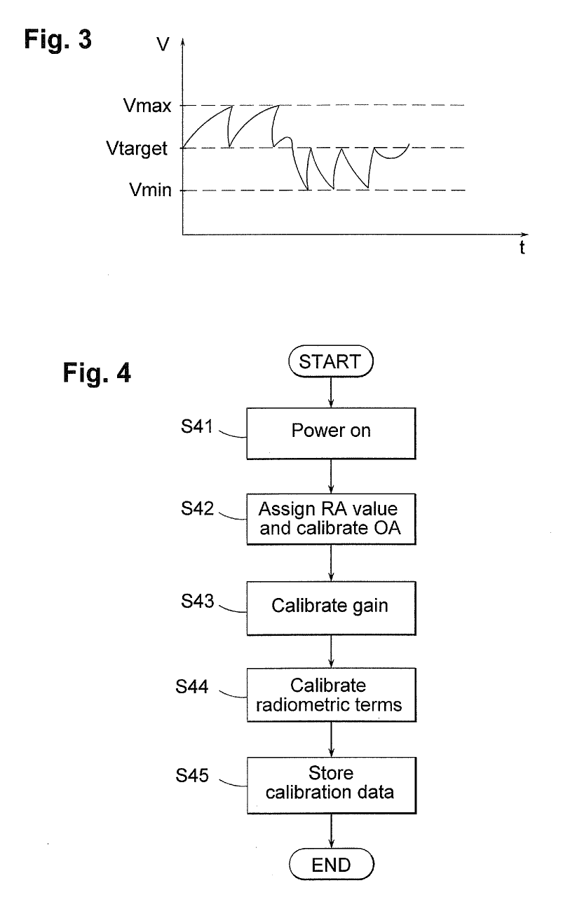

FIG. 3 illustrates the proposed correction of the output signal for a single curve of the ones shown in FIGS. 2a and 2b, representing a single pixel. This correction could be performed globally using the same values for all pixels or may be performed for each pixel individually. The minimum value Vmin and the maximum value Vmax are selected around a target value Vtarget as a suitable range within the total range (Vminout to Vmaxout) of the camera to ensure that the pixel will operate correctly in the whole of the total range. As can be seen, the curve has a sawtooth shape, indicating that the pixel is allowed to change to a maximum value Vmax or to a minimum value Vmin before it is corrected to the target value Vtarget. This correction is performed as the camera is operated.

In the discussion of FIGS. 2a, 2b and 3 a voltage output signal has been assumed. The discussion would be similar for other types of output signals. The skilled person is familiar with the correction methods to be used for each type of detector.

FIG. 4 is a flow chart of a calibration process that may be used during manufacturing to provide a camera according to an aspect of the invention.

In step S41 the camera is powered on and given time to stabilize.

In step S42 a value for a parameter affecting the temperature dependency of the detector signal is assigned to the camera and the per-pixel offset compensation is determined for the detector. The parameter affecting temperature dependency does not have to be individually adjusted for the camera. The per-pixel offset compensation is set individually for each camera. This is referred to as normalization.

In step S43 the gain is calibrated individually for each pixel using two temperature targets having different temperatures.

In step S44 the radiometric terms are calibrated using multiple temperature targets having different temperatures.

In step S45 the calibration data are stored to a memory, for example, a Flash memory.

### End of Procedure.

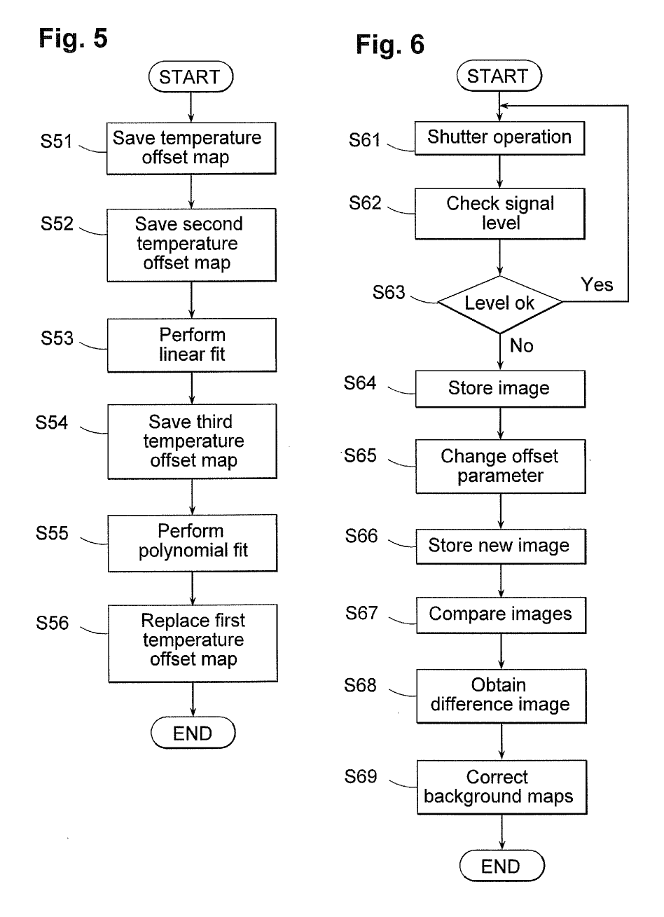

FIG. 5 is a flow chart of a calibration method according to the invention, which may be used during operation of the camera to compensate for temperature variations:

In step S51 a first temperature offset map is saved at a first shutter operation. In step S52 a second temperature offset map is saved at a second shutter operation after the temperature has changed by a first predetermined amount, for example 3 degrees C. or 5 degrees C.

To perform step S52 new maps may be recorded repeatedly at each successive shutter operation until the temperature has changed by a second predetermined amount. Preferably, the maps registered after step S51 are discarded and replaced by new maps until the temperature has changed by the second predetermined amount. Hence at the end of step S52 two maps exist: the first map taken at startup of the camera, and a second map taken after the second predetermined temperature change. Alternatively, a new temperature offset map may be registered only when temperature data indicate that the second predetermined change has occurred. It would also be possible to save a new map at each shutter operation and not discard any.

In step S53 a linear fit is performed on the data from the first map and the second map.

In step S54 a third temperature offset map is saved at a shutter operation after the temperature has changed by a third predetermined amount, which may have the same value as the first or second predetermined amount. As for step S52, new maps may or may not be recorded repeatedly at each successive shutter operation until the temperature has changed by the third predetermined amount.

In step S55 a 2^{nd} order polynomial fit is performed on the data from the first, second and third maps.

In step S56 a fourth temperature offset map is saved at a shutter operation after the temperature has changed by a fourth predetermined amount. As for steps S52 and S54, new maps may or may not be recorded repeatedly at each successive shutter operation until the temperature has changed by the fourth predetermined amount. The fourth temperature offset map may replace the first temperature offset map. The second map will then be used as the oldest map and a new polynomial fit will be obtained. In a subsequent step this map will be replaced, etc.

The temperature offset maps obtained in steps S51, S52 and S54 are images of an object having the same temperature across the whole image area and therefore together describe the variation of the pixels as a function of the ambient (focal plane array) temperature. Therefore, the temperature offset maps may be used to predict how the offset will change between two shutter operations. The fits obtained in steps S53 and S55 are used for interpolation, between the temperatures for which the data was obtained, and for extrapolation for temperatures exceeding these temperatures. Between two shutter operations the offset map is adjusted to compensate for the expected variations caused by measured temperature changes, based on the fitted data. As the skilled person will understand, the curves may be obtained by other methods than a polynomial fit, for example, based on Lagrange methods or any other suitable method.

In addition to the shutter operations described above, additional shutter operations may be performed at any time found appropriate, in which the temperature offset maps as described above are not updated. Such shutter operations may instead update a fix, static, component to the offset correction used by the signal processor. The purpose of such shutter operations is to allow for image correction at any interval found suitable, even if the conditions of required predetermined temperature changes between temperature offset map updates as described in steps S52, S54 and S56 are not met.

Of course, although the example flow chart of FIG. 5 is based on the use of three maps, the number of maps used can be selected as is seen fit; however, a total of three or four maps has been found to produce a good result. For larger number of maps of course higher-order polynomial fits may be performed, possibly giving a more precise result.

The camera software is arranged to interpolate between the temperatures for which temperature offset maps exist, or extrapolate if the current temperature exceeds those of the stored maps. The skilled person is familiar with interpolation methods that can be used to achieve this, such as Lagrange interpolation.

As is common in the art, the time between two subsequent shutter operations can vary over time. Typically shutter operations will be performed more frequently just after startup of the camera than at a later stage.

FIG. 6 is a flow chart of the procedure for adjusting the focal plane array signal ouput level to avoid saturation and at the same time correcting the per-pixel offset temperature compensation maps in accordance with what is shown in FIG. 3. In step S61 a shutter operation is performed and in step S62 the signal level detected from the shutter is compared to the desired signal level that does not cause saturation.

Step S63 is a decision step. If the signal level is within the acceptable range, then continue to perform actions related to normal shutter operations, such as updating the temperature offset correction maps, then return to step S61 and perform a new shutter operation at the appropriate time. If not, the procedure continues with step S64.

Step S64: Store a first image taken against the shutter. The image may be an average image calculated from many collected images, in order to reduce the impact of noise.

Step S65: Change an offset parameter of the detector, to adjust the signal level to within the acceptable range.

Step S65: store a second image taken against the shutter.

Step S66: compare the first and second images and obtain a difference image between them.

Step S67: Use the difference image obtained in step S66 to correct all temperature offset maps.

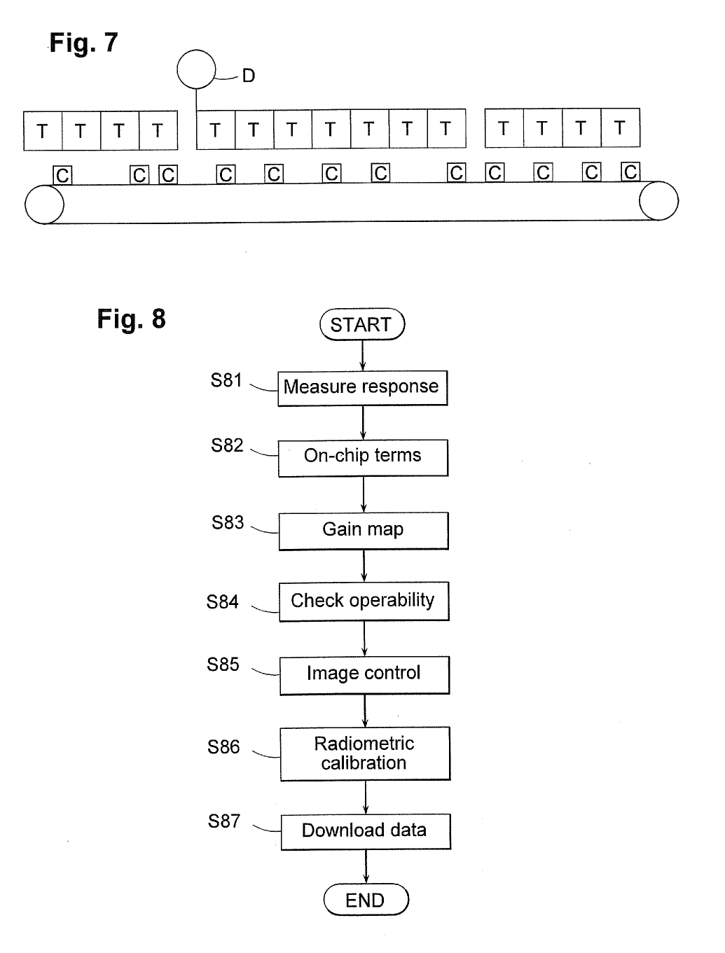

FIG. 7 illustrates a calibration line that can be used during manufacturing of cameras. The calibration line may be simplified compared to prior art calibration lines, since no temperature cycling is required. The simplest solution is to perform the entire calibration at room temperature.

Preferably, each camera comprises software that will guide the camera through the calibration line, so that no communication with the camera is required during calibration. This, too, contributes to a simple, low-cost solution.

FIG. 7 shows a conveyor belt having a number of cameras C on it, at predetermined distances. The calibration line also comprises a number of temperature targets T, each having a fixed temperature, to be imaged by each camera for calibration of the camera. At least some of the cameras C are in a position to image a target having a predetermined temperature. At fixed time intervals, for example every 60 or 75 seconds, the conveyor shifts all cameras sideways to be aimed at the next target. As mentioned above, each camera comprises the necessary software to cause it to take one or many images in each fixed time interval, or perform certain calibration procedures in the same said fixed time interval,. Preferably, the software is triggered by a temperature target device D having a predetermined temperature. The temperature target device should have a temperature that the camera will not detect accidentally, that is, a temperature that no other object in the camera's vicinity will have. When the camera is in calibration mode, this temperature will trigger the software to initialize the calibration process. The purpose of the trig is to synchronize the camera internal time reference to the positioning of the camera on the conveyor and the timing of conveyor movements. Of course, the synchronization may be achieved in any other suitable way, for example by optical or mechanical means.

As shown in FIG. 7, the conveyor belt may have empty positions.

FIG. 8 illustrates the calibration steps performed for each camera as it is moved by the conveyor belt between different stations.

In step S81 the response of the focal plane array is measured. This comprises measuring the signal received at two different temperatures, for example 35 and 100 degrees C., and calculating the response. Typically these measurements are carried out at the first and second position of the camera, respectively.

In step S82 detector parameters that affect the response and the offset level may be set in order to adjust the signal output dynamic range appropriately to the application of the infrared camera. Both per-pixel and global parameters for the whole focal plane array may be changed in this step.

In step S83 the gain of the camera system determined by measuring at two different temperatures, for example 35 and 100 degrees C. This is done at two different positions of the conveyor belt, one for each temperature. This data may be used to calculate per-pixel gain correction (gainmaps) as well as other gain compensations. In step S84, image analysis may be performed to automatically detect pixels with irregular behaviour, for example pixels exhibiting excessive noise or pixels that deviate in gain. These pixels are considered unusable for the image presentation to the user, and are therefore marked as “dead” in the calibration data. During operation of the camera, the signal level of such pixels are subsequently replaced by a value based on neighbouring pixel levels. Such methods for dead-pixel replacement is considered a standard procedure for people skilled in infrared camera technology. In step S85 image quality control is performed by various methods of image analysis. This may include measuring of temporal and spatial noise as well as image uniformity. Such methods are considered well-known for people skilled in infrared camera technology.

In step S86 radiometric calibration is performed. To do this signals are measured at a number of different temperatures, for example 4 different temperatures selected across the camera's temperature range. One position of the conveyor belt is arranged for each temperature. For each position an object having a well-defined temperature and high emissivity is arranged, so that the camera is caused to capture image of one of the temperatures at each position.

In step S87 the data are downloaded and stored in a memory means in the camera for use during operation of the camera.

As the skilled person will understand, the process shown in FIG. 8 is only an example of a calibration process. In particular, the order of the steps may be changed as seen fit, and steps may be added or omitted. Some steps may be performed at multiple positions at the conveyor. Typically, the calibration process is performed to set detector parameters, create a gain map for per-pixel gain correction, improve the image quality and ensure correct conversion between the detector signal and the object's temperature.

In a variant of the invention, one or more temperature offset map is generated during manufacturing of the camera and stored permanently as a background temperature offset map that may be used together with the temperature offset maps generated according to the above. To generate more than one temperature offset map without having to change the temperature of the calibration environment during manufacturing, the camera's self-heating may be used.

The temperature offset maps generated during operation of the camera according to the invention may also be stored for future use even if the camera is turned off.

1. An infrared camera comprising a focal plane array (5) having a number of pixels, each pixel arranged to produce an output signal in dependence of incident infrared radiation to the pixel, said camera comprising a processing unit (7), said camera further comprising computer-readable code means which, when executed in the processing unit will cause the processing unit to perform the following steps during operation of the camera:
recording the output signal of each pixel of the detector during a shutter operation
using the recorded signal from each pixel to update a temperature offset map stored in the camera to ensure uniform signal levels at different camera temperatures,
Said code means being arranged to obtain the temperature offset maps during operation of the camera by performing the following steps:
save at least a first temperature offset map during a first shutter operation at a first temperature and a second temperature offset map during a second shutter operation at a second temperature
calculating a fit based on the data from the at least first and second offset maps
using the fit to interpolate between the first and the second temperature to compensate for variations in signal output caused by temperature variations.

2. An infrared camera according to claim 1, wherein the code means is arranged to compensate for variations in signal output by adjusting the output signal level, by adjusting an internal detector parameter such as bias or offset, to avoid saturation.

3. An infrared camera according to claim 2, wherein the code means is arranged to compensate for the variations in signal output by storing an image before and after signal adjustment and using the difference between these images to adjust by at least the first or the second temperature offset map.

4. An infrared camera according to claim 2, wherein the code means is arranged to compensate for variations in signal output using the same compensation for all pixels.

5. An infrared camera according to claim 2, wherein the code means is arranged to compensate for variations in signal output individually for each pixel.

6. An infrared camera according to claim 1, wherein the computer readable code means will cause the processing unit to fit the first and second temperature offset maps to a linear curve.

7. An infrared camera according to claim 1, wherein the computer readable code means will cause the processing unit to store at least an integer number N temperature offset maps, each taken during shutter operation at a different temperature and perform an N−1 order polynomial fit on the N temperature offset maps.

8. A method of temperature compensation in a focal plane array used in an infrared camera during operation of the camera, said method comprising the following steps performed during operation of the camera:
Recording the output signal of each pixel of the detector during a shutter operation Using the recorded signal to update a temperature offset map stored in the camera to ensure uniform signal levels at different camera temperatures,
Wherein the temperature offset map is obtained during operation of the camera by the following steps:
saving at least a first temperature offset map during a first shutter operation at a first temperature and a second temperature offset map during a second shutter operation at a second temperature
calculating a fit based on the data from the at least first and second offset maps
using the fit to interpolate between the first and the second temperature to compensate for variations in signal output caused by temperature variations.

9. A method according to claim 8, wherein variations in signal output are compensated for by adjusting the output signal level to avoid saturation.

10. A method according to claim 9, wherein the variations in signal output are compensated for by storing an image before and after signal adjustment and using the difference between these images to adjust by at least the first or the second temperature offset map.

11. A method according to claim 9, wherein variations in signal output are compensate for using the same compensation for all pixels.

12. A method according to claim 9, wherein variations in signal output are compensate for individually for each pixel.

13. A method according to claim 8, wherein comprising the step of fitting the first and second temperature offset maps to a linear curve.

14. A method according to claim 8, comprising the step of storing at least an integer number N temperature offset maps, each taken during shutter operation at a different temperature and perform an N−1 order polynomial fit on the N temperature offset maps.
